(19) United States
(12) Patent Application Publication
(10) Pub. No.: US 2001/0037940 A1
(43) Pub. Date: Nov. 8, 2001

(54) Apparatus for horizontal gel electrophoresis and method of using same

(76) Inventors: Lih-Bin Shih, San Diego, CA (US); Mark A. Williams, Redwood Shores, CA (US); Patricia M. Vilalta, San Diego, CA (US); Donald Millerd, San Diego, CA (US)

Correspondence Address: Barry S. Wilson, Foley & Lardner, 23rd Floor, 402 West Broadway, San Diego, CA, 92101-3542, US

(21) Appl. No.: 09/771,308

(22) Filed: Jan. 26, 2001

Related U.S. Application Data
(60) Provisional application No. 60/178,747, filed on Jan. 28, 2000.

(51) Int. Cl. G01N 27/26; G01N 27/447

(52) U.S. Cl. 204/466; 204/616

(57) ABSTRACT

The present invention provides various electrophoretic apparatuses for discontinuous gel electrophoresis. One apparatus comprises a vessel and a removable gel cassette for holding the gel, the cassette divided into two separate compartments, each in fluid communication with a buffer reservoir. Access holes provided on the top of the cassette allow sample to be added to the gel inside the cassette. The cassette also optionally includes a gel viewing window and sample loading window. Another apparatus comprises a vessel with a raised platform in the middle on which the gel is placed and over which a gel restraining frame, generally rectangular in shape, is secured close to the gel surface. The frame when in place acts as a barrier to movement of electrode buffer between reservoirs. The frame and an open interior for buffer or fluid, which assists in gel cooling during electrophoresis.

### FIELD OF THE INVENTION

The present invention relates to an apparatus for conducting gel electrophoresis. In a particular aspect, the present invention relates to an apparatus for horizontal electrophoresis of slab gels.

### BACKGROUND OF THE INVENTION

Gel electrophoresis is a widely used method for analyzing a variety of biomolecules including nucleic acids and proteins. There are two types of buffer systems in electrophoresis, continuous and discontinuous. A continuous system has only a single separating gel and uses the same buffer in the reservoirs and in the gel. A discontinuous gel system has two different gel portions. One portion, the “stacking gel,” is a non-restrictive large pore gel and is layered over the other portion, the “resolving gel” (or “running gel”). Each portion of the discontinuous gel is prepared with a different buffer, both of which differ from the reservoir buffer. Discontinuous gels are typically cast as slabs between plates of glass.

Apparatuses for electrophoresing discontinuous gels are designed strictly for vertical electrophoresis. The longitudinal axis of the gel is positioned vertically such that the upper surface of the stacking gel contacts the upper buffer reservoir and the lower surface of the running gel contacts the lower buffer reservoir. Vertical electrophoresis of slab gels faces several problems. For example, buffer may leak from the upper reservoir to the lower reservoir and, if not detected, can cause disruption of electrophoresis if the upper reservoir runs dry. Also, if a leak is detected, removal and re-securing of the gel in a vertical apparatus already loaded with buffer can result in buffer spillage or even loss of sample.

Furthermore, the glass plates used for casting slab gels in vertical electrophoresis require the application of strong pressure to separate the plates, exposing the gel to damage and the worker to injury. Additionally, the stacking of buffer reservoirs in a vertical electrophoresis apparatus limits the usefulness of the buffer for cooling of the gel.

A typical horizontal electrophoretic apparatus comprises a vessel with a step-up-(raised) platform across the middle that divides the vessel into three segments, a set of horizontal buffer reservoirs and the raised platform. A gel tray with gel is placed on the step-up-platform and the buffer reservoirs are overfilled until the buffers are confluent and the gel is submerged below. Such horizontal slab gel electrophoresis apparatus of the prior art, however, is not suitable for electrophoresing discontinuous gels because the requirement to submerge the gel in electrophoresis buffer will detrimentally effect the pH of the stacking and resolving gel portions. Also, it would not be possible to use a different electrode buffer in each reservoir as called for in some discontinuous gel systems because the horizontal apparatus of the prior art overfilled the reservoirs until confluence was reached. Thus, it would be useful to have a simple and effective apparatus for horizontal electrophoresis of discontinuous slab gels. Such apparatus should minimize the problems associated with horizontal devices such as leaking from the upper buffer reservoir. It also would be useful if the apparatus eliminated the need for casting between glass plates.

### SUMMARY OF THE INVENTION

Accordingly, to minimize problems associated with horizontal devices such as buffer reservoir leaking, limitations on slab gel cooling, and potential for damage and injury when removing gels from between glass plates, the inventors have prepared different electrophoretic apparatuses which, for the first time, makes possible discontinuous horizontal gel electrophoresis in a specifically designed assembly. One apparatus comprises a vessel and a removable gel cassette for holding the gel. The cassette is divided into two separate compartments, each in fluid communication with one of the buffer reservoirs. Access holes are provided on the top of the cassette to allow sample to be added to the gel when enclosed in the cassette. Gasket material for sealing is used between the two halves of the cassette and between on end of the cassette and a buffer reservoir. A gel cover may be used to insulate the gel from buffer inside the cassette or to prevent drying. The apparatus also has a number of additional features including a cassette gel viewing window, a cassette sample loading window and optionally an apparatus cover.

Another apparatus comprises a vessel with a raised platform in the middle on which the gel is placed and over which a gel restraining frame, generally rectangular in shape, is applied. The frame is secured in place close to the gel surface, thus acting as barrier to movement of electrode buffer between reservoirs when the reservoirs are filled high enough to contact each end of the gel. Gasket material on the frame may be used to insure against leakage between the frame and the inside wall of the vessel. A gel cover may be used to insulate the gel from buffer inside the cassette or to prevent drying. The frame has an open interior for buffer or fluid, which helps to cool the gel during electrophoresis. The apparatus has a number of additional features including optionally an apparatus cover.

Also provided herein are methods for using the above apparatuses for gel electrophoresis including discontinuous gel electrophoresis.

### BRIEF DESCRIPTION OF THE DRAWINGS

FIG. 1 is an exploded view of an electrophoresis apparatus of the invention.

FIG. 2 is a top view of the electrophoresis apparatus shown in FIG. 1 except that the cover is not included.

FIG. 3 is a transparent side view and partial cross section of the electrophoresis apparatus shown in FIG. 1 except that the cover is not included.

FIG. 4 is an exploded view of the cassette, gasket and gel tray of the electrophoresis apparatus shown in FIG. 1.

FIG. 5 is an enlarged view of the cam taken substantially along the lines 5-5 in FIG. 1.

FIG. 6 is an exploded view of an electrophoresis apparatus of the invention.

FIG. 7 is a top view of the electrophoresis apparatus shown in FIG. 6.

FIG. 8 a cross-sectional view of the electrophoresis apparatus shown in FIG. 7 taken substantially along the lines 8-8 in FIG. 7. A cover not shown in FIG. 7 is included in this figure.

FIG. 9 is a top view of the gel restraining frame shown in FIG. 6.

FIG. 10 is a side view of the gel restraining frame shown in FIG. 6.

FIG. 11 is a front view of the gel restraining frame shown in FIG. 6.

FIG. 12 is a cross-sectional view of the gel restraining frame taken substantially along the line 12-12 of FIG. 9.

FIG. 13 is a cross-sectional view of an alternative embodiment of a gel restraining frame similar to that shown in FIG. 12.

FIG. 14 is a cross-sectional view of an alternative embodiment of a gel restraining frame similar to that shown in FIG. 12.

### DETAILED DESCRIPTION OF THE INVENTION

The present invention provides various apparatuses for performing horizontal slab gel electrophoresis suitable for analysis of biomolecules in discontinuous or continuous gels. One apparatus comprises a vessel prepared from electrically nonconductive material having a first and a second buffer solution reservoir. Each reservoir of the vessel has an electrode which extends outside the vessel for attachment to a power supply. The vessel is configured to hold a gel cassette substantially parallel inside the vessel. The gel cassette, also prepared from electrically nonconductive material, is configured to contain a slab gel inside the vessel. The cassette has a first end and a second end, and when the cassette is secured in the vessel, each end of the cassette is oriented towards a buffer reservoir. The gel cassette also comprises at least a first and a second compartment, wherein the first compartment is in fluid communication with one or more openings at the first cassette end and the second compartment is in fluid communication with said one or more openings at said second cassette end. This configuration provides buffer solution access to a first and a second end of a slab gel secured in the cassette when it is positioned in the vessel. The cassette also includes one or more access holes on top and proximal to one end of the cassette to allow loading sample into wells of a gel secured inside the cassette.

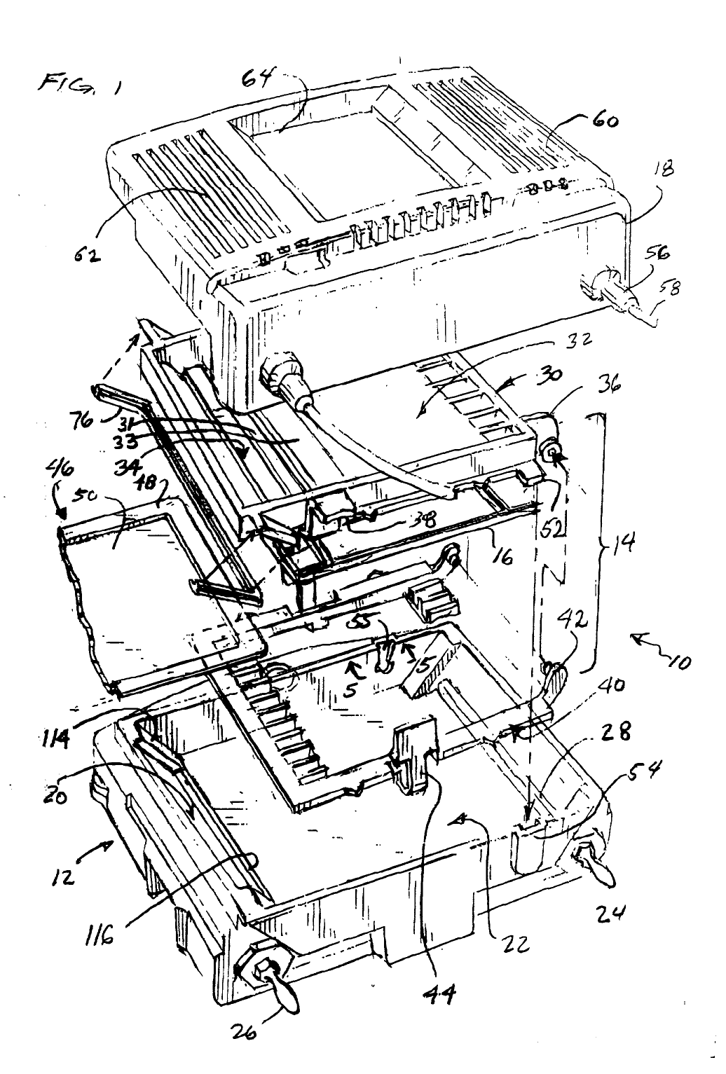

An embodiment of this apparatus, which is shown as 10 in FIG. 1, in general, comprises a vessel 12, gel cassette 14 comprising a top portion 30 and bottom portion 40. Also shown are gasket 16, gel tray 46 and apparatus cover 18. The vessel and cassette are made from material suitable for conditions encountered during electrophoresis (i.e., electric current, heat, variable pH, and the like).

Vessel 12 is divided into two fluid-tight buffer reservoirs, 20 and 22. Reservoir 22 is substantially larger than reservoir 24, enabling the cassette to fit substantially within the reservoir 22. The design of the cassette and its placement within buffer reservoir 22 allows the large volume of buffer in that reservoir to cool both the top and bottom surfaces of the gel during electrophoresis.

The gel cassette of the invention is used to hold the slab gel in position in the vessel and provide appropriate contact with electrophoresis buffer (also referred to as electrode buffer). The cassette is sized to fit into the vessel. As shown in FIG. 1, gel cassette top portion 30 and bottom portion 40 are connected by hinge parts 36 and 42, forming hinge 47 (FIG. 4). Cassette top portion 30 includes V-shaped cross member 35 serving as a dam and having a pair of legs 31 and 33, which function to divide the cassette into two main compartments, 78 and 80 seen in FIG. 3. The hinge linkage is helpful to align the two cassette portions during assembly, but is not essential.

The slab gel is preferably formed in a suitable gel tray designed to fit into the cassette. The tray acts as a receiver of gel prior to solidification and also is useful for storing the gel. As used herein, a slab gel is a substantially planar gel made of a material commonly used by those of skill in the art for the separation of biological materials. Such materials include polyacrylamide, agarose, any of a variety of gellable polymers such as crosslinked polymers of N-vinyl pyrrolidone-based polymers, methacrylic acid-based polymers (e.g., glyceryl methacrylate-based polymers, 2-hydroxyethylmethacrylate-based polymers, and the like), acrylic acid-based polymers, and the like (see, e.g., U.S. Pat. 5,388,365 to Shih).

Recipes for preparing any of a variety of gels are well known in the art including the use of combs to form the sample wells in the gel. A preferred gel tray 46 includes a base 50 on which the gel can be initially poured into and raised sides 48 to contain the gel liquid before it solidifies. Loading of the gel tray with the gel into the cassette is facilitated by two sets of guide members (see one set as 100 and 102 in FIG. 4), which are vertical protrusions attached to outcroppings at the sides of lower cassette portion 40. The guide members are not essential.

Buffer separation structure shown as gasket 16 is present between cassette top 30 and cassette bottom 40 (FIG. 1). As used herein, “buffer separation structure” means any structure that can be brought into sealing engagement with an electrophoresis slab gel. “Sealing engagement” means a substantially fluid-tight seal. By “substantially fluid-tight seal” is meant a seal that can serve to maintain separate buffer solutions on either side of the seal under standard gel running conditions. Thus, while some leakage can be accommodated, it should not result in the homogenization of buffers maintained on either side of the seal. Separation structures contemplated for use in the practice of the present invention include gaskets, flanges, and the like. Gaskets and flanges may be of rigid or flexible material. Flexible materials contemplated for use in the practice of the present invention include rubber, and the like.

Gasket 16 is substantially rectangular in shape and comprises two parallel elongated sections of similar length material 104 and 106 (see FIG. 4.). One end of each elongated section is connected by a first cross member section 108 while a second cross member section 110 is located near first cross member 108. A third cross member section 112 connects members 104 and 108 near the end opposite cross member 108. Proper positioning of gasket 16 in the cassette is assisted by a shallow recess 88 in cassette top portion 30. The addition of a small amount of grease to gasket 16 optionally can be used to hold the gasket in recess 88 when securing a gel between the cassette portions.

Gasket sections 104 and 106 function to seal against buffer leakage through the sides of the cassette and assist in securing the sides of the gel to the cassette bottom portion 40. Gasket section 108 combines with cross member 35 to divide the cassette into two main compartments 78 and 80 with the gel forming the bottom of these compartments (see FIG. 3). Compartment 78 is in fluid communication with buffer from reservoir 20 that passes through opening 92 in the end of the cassette top portion 30. Gasket members 108 and 110 function to maintain buffer that enters compartment 78. Compartment 80 is in fluid communication with buffer from reservoir 22 that passes through opening 98 (see FIG. 4). Gasket members 110 and 112 function in concert with a gel cover to insulate the gel below from contact with electrophoresis buffer and to maintain buffer from leaking out of compartment 80.

A gel cover 96 (i.e., top cover) (FIG. 4), sized to extend to the outside edges of gasket 16, is positioned over gel 93 so that when the top and bottom portions of the cassette are closed, gasket portions 104, 106, 110 and 112 seal against the edges of the gel cover. A gel cover can be made from relatively rigid to flexible material which is transparent. A flexible material is preferably a thin plastic film.

The gel cover can be used to assist gellation of particular type gels. Also, when used during electrophoresis, the gel cover protects the gel from damage by pressure from sealing gasket 16 and insulates the portion of the gel below the cover from contact with electrophoresis buffer. A gel cover may not be necessary in all cases, such as when the top cassette portion 30 is configured so that buffer has only limited access into compartment 80.

When the gel is in the cassette with a gel cover, buffer in the larger reservoir is allowed to contact a short section at the end of the gel 91 (FIG. 4) which lies outside gasket section 112. The portion of the gel under the gel cover 96 is insulated from contact with buffer entering compartment 80. Buffer from reservoir 20 that enters cassette compartment 78, as discussed above, makes contact with the other end of the gel (see 93 in FIG. 4) where the sample wells 94 are located. Buffer from reservoir 22 that enters compartment 80 cools the upper surface of the gel during electrophoresis while the underside of the gel is cooled by buffer from reservoir 22 provided by a large open area (see 95 in FIG. 4) at the bottom of cassette lower portion 40.

Gel cassette top portion 30 has a longitudinally-shaped trough 34 (FIG. 1), providing access from above into compartment 78 (FIG. 3). The access hole is sufficient to allow a user to insert a pipette tip to deliver sample to wells of a gel secured in the cassette. As discussed above, angled cross members which form a depression in the top surface of the top cassette portion function to divide the cassette into two main compartments. When made from transparent material, cross member leg 31, being angled downwards into the cassette and towards the wells, provides a well loading window to assist with sample in sample loading. The angling of cross member leg 31 towards the sample wells acts as a “diving mask” when buffer fills the area above the wells and contacts the underside of cross member leg 31.

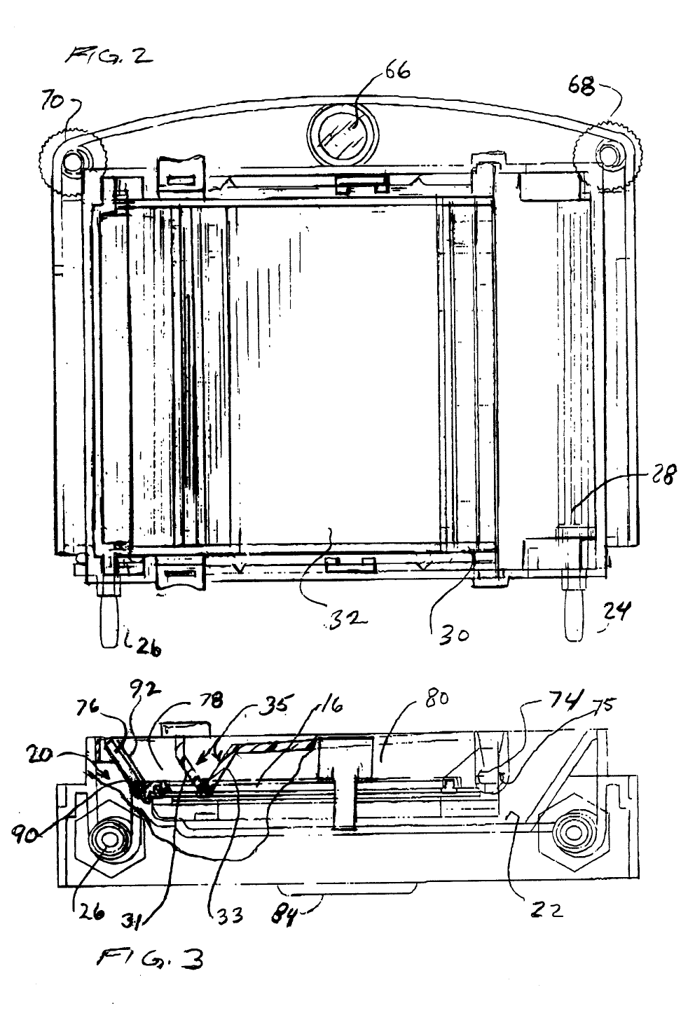

Gel cassette top portion 30 includes a large transparent gel viewing window 32 (see FIG. 1 and 2) which is positioned so that the gel will be visible below the window when the gel is enclosed in the cassette. To avoids fogging of window 32 during electrophoresis, buffer in compartment 80 should preferably be filled until it contacts the underside of window 32. However, window 32 may be eliminated and the top of the cassette open to allow moisture and heat to escape. Alternatively, window 32 may be a series of vents which provide partial covering while allowing for moisture and heat to escape.

Transparent window 32 above the gel is useful for monitoring the progress of the electrophoresis, with the end of the run commonly signaled by the position of one or more dyes. Only the top portion of the cassette need be transparent for gel viewing, although all of the cassette can be made of transparent material if desired. Window 32 is not required and may be removed in an alternative design, leaving an open area in its place. The cassette, or portion thereof such as window 32 may be constructed from UV transparent materials so as to visualize the position of biological materials in the gel during electrophoresis that are complexed with one or more dyes which fluorescence under excitement by UV radiation. (e.g., radiation at A₂₄₀, A₂₆₀, and the like)

As is apparent from FIGS. 1-3, the cassette is positioned substantially horizontally within the vessel 12, mainly within buffer reservoir 20. The position of the cassette in the vessel is controlled by pairs of attachment structures. As used herein, attachment structure pairs include any type of fastener pairs or attachment assemblies well known in the art such as a hook and loop, a set of hinge halves, detent type fasteners, cam assemblies and the like.

A cam assembly can be used for initially positioning the cassette in the vessel. To this end, the cassette is held substantially perpendicularly and cam followers 52 and 53 seen in FIG. 4, extending outwards from the cassette bottom portion 40, are guided into recesses 54 and 55, respectively (see FIG. 1) in the walls of vessel 12. When the cassette reaches the bottom of the recess, cams in the recesses (see 74 in FIG. 3) guide the cam followers which directs the other end of the gel into position until the cam followers reach a stop in the cam (see 75 in FIG. 3). A close up view of the cam and cam follower interaction is shown in FIG. 5. At this point the gel cassette is orientated substantially parallel to the vessel and is situated substantially within buffer reservoir 22. The other end of the cassette (opposite the sides with the cam assemblies) also is preferably secured by one or more attachment structures. As seen in FIGS. 1 and 4, such securing can be achieved by a pair of detent fasteners (see 38 in FIG. 1). Detent fastener 38 (FIG. 4) is an S-shaped structure, the bottom end being integral to the cassette top portion. A ball or other protrusion 86 extends from the upper part of the S-shaped structure on the side away from the cassette (FIG. 4). When the end of the cassette with the detent fasteners is pressed into position into the vessel, the S-shaped structure presses the ball or other protrusion against the inside wall of the vessel where it contacts a recess, securing the ball or other protrusion into position. Disengaging the detent fastener is facilitated by the top most portion of the S-shaped structure which extends above the vessel for easy detachment when the cassette is fully in position in the vessel. When the detent fastener 38 is properly secured, gasket 76 (FIG. 3), located between opening 92 at one end of the top cassette 30 and the area that directly borders buffer reservoir 20 (see 114 and 116 in FIG. 1), is brought into a sealing engagement, thereby resulting in a substantially fluid tight connection between buffer reservoir 20 and cassette compartment 78.

In an alternative design, the U-shaped gasket 76 and the slanted end connected to section of the top cassette portion upon which gasket 76 rests may be made integral to the vessel. In this way, gasket 76 would be made from the same material as the vessel. Sealing in this embodiment between cassette and reservoir 20 could be accomplished, for example, by expanding the width of gasket member 108 on the side facing reservoir 20, providing a smaller seal overall in this design compared to 76 in FIG. 4.

The electrophoresis apparatus also optionally includes an apparatus cover such as 18 shown in FIG. 1, which is secured above the cassette/vessel assembly to protect a user from electrical shock. The cover 18 preferably has an open window 64 located over the gel in the cassette. In an alternative design, the window may be filled in with a transparent solid section or with a series of vents. If the top of the cassette is closed as shown in FIG. 1, then window 64 could be open also shown in FIG. 1. However, if the top of the cassette is open, then window 64 should be fully covered or partially covered with vents.

Vents such as 60 and 62 in cover 18 can be positioned above the reservoirs or the gel to allow moisture and heat to escape the apparatus. Banana plugs (see 56 in FIG. 1) mate to connectors on the vessel (see 24 in FIG. 1), each connector attached to an electrode wire in a buffer reservoir (see electrode wire 28 for reservoir 22 in FIG. 1). The banana plugs are connected by wires (see 58 in FIG. 1) to a power supply (not shown). To insure that the gel is horizontal and level during electrophoresis, vessel 12 is provided optionally preferably with a bubble level 66 and legs 68 and 70 which move up and down by means of thumbscrews (FIG. 2). Fixed leg 84 (FIG. 3) also supports the vessel.

The present invention also provides methods to use the electrophoresis apparatuses described above for either discontinuous or continuous buffer systems. Biomolecules contemplated for separation in accordance with the present include, for example, proteins including polypeptides and peptides, nucleic acids including DNA, RNA, polynucleotides and oligonucleotides, carbohydrates, lipids, glycolipids, glycoproteins and proteoglycans, and charged polyamine materials (both natural or synthetic) and the like.

In the apparatus design which includes a cassette, the gel is preferably formed in a gel tray which provides a receiver for the gel solution and storage for the gel following solidification. Recipes for preparing any of a variety of gels are well known in the art and include, for example, discontinuous SDS-PAGE (see e.g., Laemmli, Nature, 227:680-685 (1970)). When forming a gel, the gel cover may be applied to the gel surface after pouring the gel if covering does not inhibit solidification of the gel (i.e., gellation) such as in the case where gellation occurs in the presence of water vapor. In other cases, the gel cover should be in place soon after the gel is poured to assist in gelation if this process is inhibited by the presence of oxygen.

Once the gel is solidified, the gel tray optionally with gel cover in place is inserted between the guides on the lower cassette portion. With the gasket in place, the top and bottom portions of the cassette are brought together and secured by a suitable attachment structure, which may be a pair of T-shaped holding tabs attached to living hinges (see 44 and 45 in FIG. 4). The gel cover should be positioned in the cassette so that the sample wells are not covered leaving optionally about 1 mm of the gel end opposite the wells uncovered.

The cassette after gel loading is secured horizontally into the vessel using appropriate attachment structures such as the cam assemblies and the detent fasteners described above. A bubble level can be used to insure that the gel is horizontal by adjusting the height of leveling legs. Once the cassette is in place, the buffer reservoirs are filled with electrophoresis buffer, which can be the same in both reservoirs or may be different for each reservoir, depending on the electrophoresis protocol used. Buffer is added until the internal compartments of the cassette are filled. Buffer reservoir volume sufficient for electrophoresis in the vessel shown in FIG. 1 is about 25 ml in the smaller reservoir 20 and about 125 ml in the larger reservoir 22. One of skill in the art can easily modify the size of the apparatus including the volumes of each reservoir if different buffer volumes are desired in the each reservoir.

Following buffer loading, sample is loaded into the wells, an apparatus cover is preferably placed over the apparatus and the electrodes are connected to a power supply. The larger volume buffer reservoir (see 22 of FIG. 1) surrounds the top and bottom surfaces of the gel while voltage is applied, providing for heat dissipation during electrophoresis. Once the samples have migrated a sufficient distance in the gel, generally revealed by the use of one or more dyes (e.g. bromphenol blue for SDS-PAGE), the voltage is disconnected and the gel removed from the apparatus.

Also provided herein is a horizontal apparatus for discontinuous gels that does not use a cassette. The apparatus comprises a vessel prepared from electrically nonconductive material having a step-up platform which divides the vessel into a first and a second buffer solution reservoir, each reservoir having an electrode located therein. The platform has a height that is less than the height of the vessel and the platform has an upper surface upon which a slab gel can be located. The apparatus also includes a gel restraining frame prepared from electrically nonconductive material and generally rectangular in shape. The frame comprises four longitudinal members surrounding an interior space, wherein two of said longitudinal members are adapted to face toward a buffer reservoir and the other two longitudinal members are adapted to face to the inside wall of the vessel. The frame is adapted to be secured in the vessel directly over and sufficiently close to the upper surface of a gel so that electrophoresis buffer from each reservoir can contact an edge of a gel but the buffer is substantially blocked from passing underneath the frame or around the frame.

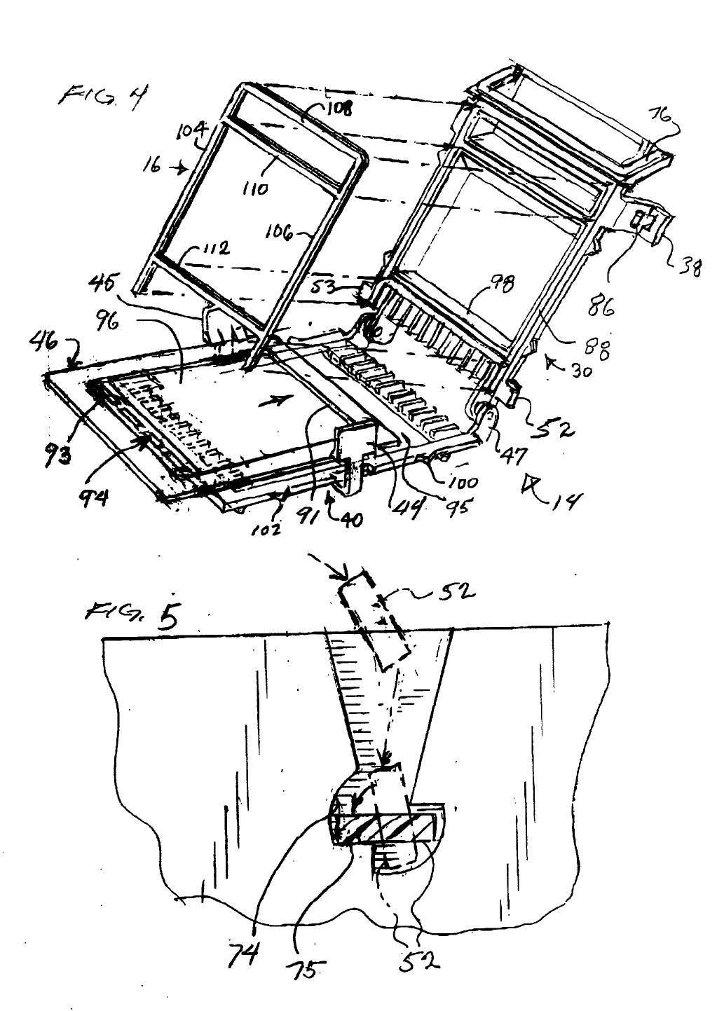

An embodiment of this apparatus is shown as 210 in FIG. 6 and comprises a vessel 212, and gel restraining frame 230. The vessel 212 has a step-up platform 218 and electrode connectors 220 and 222 which connect to electrodes in the buffer reservoirs.

For assembly, slab gel 226 with optional film support (indicated 224) below the gel is placed on step-up platform 218. A gel restraining frame 230, made from electrically nonconductive material, comprises longitudinal members 232, 234, 236 and 238, which connect to form an interior space 240. In a preferred embodiment, the dimension of frame members 232 and 234 are substantially similar to the transverse dimension of the step-up platform 218 (FIG. 7), while the dimension of frame members 236 and 238 are slightly shorter than the longitudinal dimension of the step-up platform 218. This difference in longitudinal dimension allows for the wells of the gel to remain outside the frame when assembly of the gel and frame are complete (see FIG. 7).

Gaskets 242 and 243 (FIGS. 6 and 9-11) are located in a recess along the bottom and the sides of the outside face of the longitudinal members (236 and 238 in FIG. 6) that face the interior walls of the vessel (e.g., 244), to provide sealing between the sides of the frame that oppose the interior walls of the vessel. Such sealing should be sufficient to substantially block movement of buffer between the two reservoirs when the reservoirs are over-filled above the level of the gel but below the highest level of the restraining frame. It will be understood that gasket material also can be added to the underside of frame members 232 and 234 (FIG. 6) so as to improve sealing where these frame members contact the surface of the gel or the surface of a gel cover if used. Also, gasket material 242 and 243 may be associated with the inside of the vessel (e.g., at 244 in FIG. 6) rather than attached to the frame.

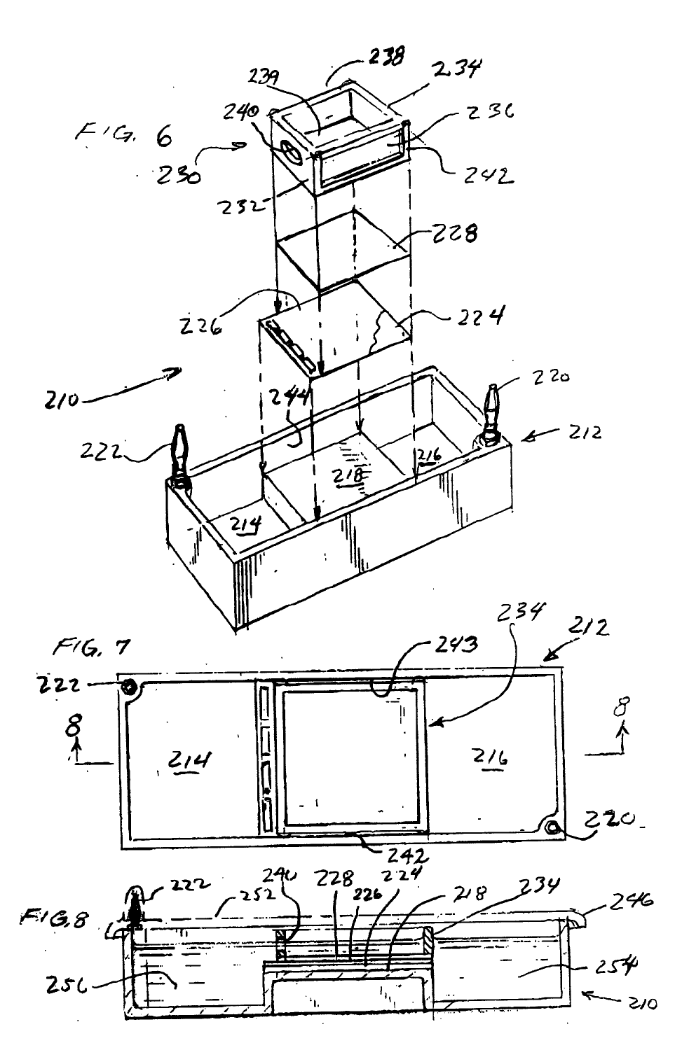

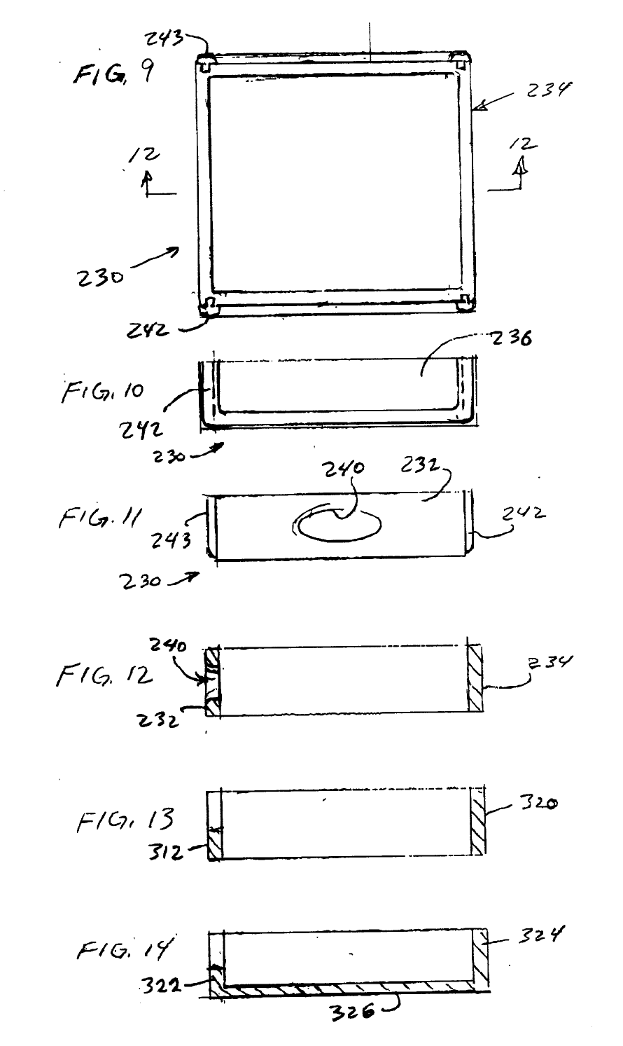

A gel cover 228, similar to the gel cover discussed above, covers the majority of the surface of the gel, excluding the area where the wells are located (see FIGS. 6 and 7). The gel cover can be used to assist gellation of particular type gels as discussed above and may be used during electrophoresis to help seal between the bottom of the restraining frame and the top surface of the gel and/or top of the gel cover if utilized (FIG. 8). In another embodiment, the gel cover may be integral to the restraining frame as indicated by 326 in FIG. 14. It will be readily appreciated by the ordinary skilled artisan that the integral gel cover shown as 326 in FIG. 14 could also be used with the frame shown in 11. A gel cover may not be necessary if gasket material is located on the underside of each member of the restraining frame.

Longitudinal member 232 of the restraining frame has an access hole 240 (FIGS. 6 and 11) and when the frame is positioned over the gel as indicated in FIG. 7, the access hole 240 will admit buffer from reservoir 214 (when over-filled) into the interior of frame 239 (FIG. 8). Buffer that collects in the interior situated above the gel provides a source of gel cooling during electrophoresis. It will be understood that the position of the frame can be reversed from that shown in FIG. 6 such that frame member 232 with hole 240 faces buffer reservoir 216 while frame member 234 faces buffer reservoir 214. By orienting the frame in this manner, the buffer in 214 need be filled only to the height where the wells of the gel are just submerged (preferably about 1 mm above the wells) while reservoir 216 may be filled so that the interior 239 of the frame 230 contains a sufficient amount of buffer for cooling. This makes sample loading easier while maximizing the volume of buffer for gel cooling.

In alternative embodiments, buffer access to the inside of the frame is provided using longitudinal member 312 and 322 as shown in FIGS. 13 and 14, respectively. In this case, with the bottoms of the members aligned, members 312 or 322 are shorter in height than the other members. It should be understood that in embodiments where the vessel is configured to provide cooling below the gel tray (e.g. cooling inside the step-up platform), then access hole 240 may be eliminated.

The gel electrophoresis apparatus with the gel restraining frame in conjunction with the step-up platform is used in a manner similar to the cassette containing apparatus described above. Gel formation is the same as described above. Preferably, the gel is formed over a thin film that has the same outer dimensions as the gel. This simplifies the step of gel transfer in the vessel. Once the gel is formed, the gel tray with gel and optionally with the gel cover is placed on top of the step-up platform of the vessel. The gel restraining frame is pushed down over the gel and positioned just at the top surface of the gel or the top surface of the gel cover. As shown in FIG. 7, the wells of the gel are outside the frame when the frame is in position. The buffer reservoirs are filled with electrophoresis buffer (254, 256) to just above the height of the gel. The frame can be adjusted down further towards the gel if buffer is determined to be leaking below the frame into the frame interior. If no leaking is seen, the buffer level can be raised in each reservoir so that buffer enters the interior of the frame through the access hole in the frame if present and submerges the gel wells. If the frame does not have an access hole, an appropriate fluid can be added to the interior of the frame to provide cooling.

Following buffer loading, sample is loaded into the wells. As in the other apparatus, the vessel can be leveled by adjusting screws.

An apparatus cover such as 246 in FIG. 8, which includes vents over the buffer reservoirs (see 252 as an example) and over the gel is preferably placed over the apparatus, the electrodes are connected to a power supply and a voltage applied through the gel. Once the samples have migrated a sufficient distance in the gel, generally revealed by the use of one or more dyes, the voltage is disconnected and the gel removed from the apparatus.

An alternative method for achieving discontinuous electrophoresis that would eliminate the need for a buffer reservoir and seals, is to enclose the gel on both top and bottom sides in an evaporation-resistant material that would include regions allowing for attachment of wicks at the anode and cathode end which would attach to an electrical source. The wicks could comprise any material that is compatible with a mixture of electrolytes and would allow for conduction of electricity, for example paper, agarose, agar, starch, polyacrylamide, hydrogel, and the like. Another alternative is to include conductive strips on the inside of the gel tray, the vertical edges at the anode and the cathode end of the gel in electrical contact with a power source. The gel tray and a close-fitting top cover would be made of a non-conductive, evaporation resistant material. Application of electrical power would be made directly to the gels with no need for buffer reservoir or cassette. In this case, the vessel could include a temperature controlling device to maintain a user-defined or automatically controlled temperature of the gel. The device could include circulating liquid that would add or carry away heat, or could include an electronic device that would regulate the temperature of a metal, ceramic or other material that would be in contact with the gel cassette and gel.

The invention thus has been disclosed broadly and illustrated in reference to representative embodiments described above. Those skilled in the art will recognize that various modifications can be made to the present invention without departing from the spirit and scope thereof. All publications, patent applications, and issued patents, are herein incorporated by reference to the same extent as if each individual publication, patent application or issued patent were specifically and individually indicated to be incorporated by reference in its entirety.

What is claimed is:

1. An apparatus for horizontal gel electrophoresis, said apparatus comprising:
a) a vessel prepared from electrically nonconductive material having a first and a second buffer solution reservoir, each reservoir having an electrode located therein, said vessel configured to hold a gel cassette substantially parallel therein; and
b) a gel cassette prepared from electrically nonconductive material configured to contain therein a slab gel, said cassette having a first end and a second end, said cassette end adapted such that said first cassette end is oriented towards said first buffer reservoir and said second cassette end is oriented toward said second buffer reservoir when said gel cassette is positioned in said vessel, said gel cassette comprising at least a first and a second compartment, wherein said first compartment is in fluid communication with one or more openings at said first cassette end and said second compartment is in fluid communication with said one or more openings at said second cassette end, thereby providing buffer solution access to a first and a second end of a slab gel secured in said cassette when said cassette is positioned in said vessel, said cassette having one or more access holes on top of the cassette and proximal to one end of the cassette so as to allow loading of sample into wells of a gel secured inside said cassette.

2. An apparatus according to claim 1, further comprising a gel cover prepared from electrically nonconductive material, said cover functioning to insulate the portion of the gel below the cover from contact with electrophoresis buffer that enters a cassette compartment.

3. An apparatus according to claim 2, wherein said gel cover comprises is a thin transparent film material.

4. An apparatus according to claim 1, wherein said vessel is configured to receive said gel cassette substantially within said first buffer solution reservoir.

5. An apparatus according to claim 1, wherein said gel cassette is positioned substantially horizontally in said vessel above the bottom of a buffer reservoir so that buffer can contact the underside of said gel cassette to aid in the transfer of heat away from a gel during electrophoresis.

6. An apparatus according to claim 1, wherein said gel cassette comprises transparent material providing the ability to visually inspect a gel contained within said gel cassette when said cassette is positioned in said vessel.

7. An apparatus according to claim 1, further comprising buffer separation structure for sealing said first and second compartments of said cassette and for securing said gel within said cassette.

8. An apparatus according to claim 7, wherein said buffer separation structure comprises one or more gaskets positioned between one end of said cassette and its corresponding buffer solution reservoir.

9. An apparatus according to claim 1, wherein said vessel further comprises at least one set of attachment components, said attachment components comprising a first and second component designed to mate in a restraining manner.

10. An apparatus according to claim 9, comprising two pairs of attachment components wherein one of each pair of attachment component comprises a cam follower and the other comprises a cam.

11. An apparatus according to claim 10, wherein said cam is configured so as to rotatably receive the cam follower therein, such that the gel cassette is initially oriented substantially perpendicular to the vessel when the cam follower contacts the cam in a first position, and wherein the gel cassette is orientated substantially parallel to the vessel when the cam follower is rotated in the cam to a second position.

12. An apparatus according to claim 9, wherein the set of attachment components comprises a pair of detent fasteners.

13. A apparatus according to claim 1, wherein said gel cassette comprises a UV transparent material.

14. The apparatus according to claim 1, further comprising a gel tray for forming a gel thereon and for positioning said gel wherein the cassette.

15. An apparatus according to claim 1, wherein said gel cassette comprises a top part and a bottom part adapted to support the gel therebetween when said top and bottom parts are brought together.

16. An apparatus according to claim 15, wherein the top and bottom portions of the cassette are secured together by a set hinged holding tabs located on opposing sides of said cassette.

17. An apparatus according to claim 15, further comprising buffer separation structure positioned between said top and bottom cassette portions.

18. An apparatus according to claim 17, wherein said buffer separation structure comprises one or more gaskets.

19. An apparatus according to claim 18, wherein said gasket is substantially overall rectangular in shape, said gasket comprising two substantially parallel elongated sections of similar length, wherein one end of each elongated section is connected by a first cross member section, a second cross member section is located near to the first cross member section forming a small rectangular shape, and a third cross member section is located near to the other end of said elongated sections forming a large rectangular shape.

20. An apparatus according to claim 1, wherein said cassette is made from transparent material.

21. An apparatus according to claim 1, further comprising a cover that substantially covers the cassette and the buffer reservoirs.

22. An apparatus according to claim 21, wherein said cover includes plugs for electrically connecting electrodes in said vessel to a power source.

23. An apparatus according to claim 21, wherein said cover is vented.

24. An apparatus according to claim 21, wherein said cover includes an opening positioned over the cassette when the cassette is secured in said vessel and said cover is attached to the vessel.

25. An apparatus according to claim 1, wherein the top of said cassette includes a transparent sample loading window proximal to said one or more access holes, said sample loading window angled downwards into the cassette and towards wells of a slab gel, said loading window providing the ability to see such wells so as to assist in sample loading.

26. A gel cassette for conducting horizontal slab gel electrophoresis in a vessel, said cassette comprising an electrically nonconductive material in a generally rectangular shape, said cassette having a first and a second end, each end having one or more openings allowing buffer solution to enter said ends of the cassette and contact an end of a gel positioned therein, said cassette having at least a first and a second compartment, wherein said first compartment is in fluid communication with one or more openings at said first cassette end and said second compartment is in fluid communication with said one or more openings at said second cassette end, thereby providing buffer solution access to a first and a second end of a slab gel positioned within said cassette when said cassette is positioned within said vessel.

27. A gel cassette according to claim 26, wherein said cassette comprises a top and a bottom portion adapted to support a gel therebetween when said top and bottom portions are brought into contact.

28. A gel cassette according to claim 26, wherein said cassette has one or more access holes on top and proximal to one end of the cassette, said holes configured to allow loading of sample into wells of a gel secured inside said cassette.

29. A gel cassette according to claim 26, wherein the top of said cassette includes a transparent sample loading window proximal to said one or more access holes, said sample loading window angled downwards into the cassette and towards wells of a slab gel, said loading window providing the ability to see such wells so as to assist in sample loading.

30. A gel cassette according to claim 26, further comprising buffer separation structure to provide sealing between said top and bottom cassette portions.

31. A gel cassette according to claim 26, further comprising buffer separation structure to provide sealing between said first and second compartments.

32. A gel cassette according to claim further 26, further comprising buffer separation structure near said one or more openings at said first or second end of said cassette to provide sealing between the one or more openings and a buffer reservoir of an electrophoresis vessel.

33. A gel cassette according to claim 26, wherein said cassette is constructed from transparent material.

34. A gel cassette according to claim 26, further comprising one or more attachment components for positioning said cassette substantially horizontally in an electrophoresis vessel.

35. An apparatus for horizontal gel electrophoresis, said apparatus comprising:
a) A vessel prepared from electrically nonconductive material having a step-up platform which divides the vessel into a first and a second buffer solution reservoir, each reservoir having an electrode located therein, said platform having a height that is less than the height of the vessel, said step-up platform having an upper surface upon which a slab gel can be located;
b) A gel restraining frame prepared from electrically nonconductive material and generally rectangular in shape, comprising four longitudinal members surrounding an interior space, wherein two of said longitudinal members are adapted to face toward a buffer reservoir and the other two longitudinal members are adapted to face to the inside wall of said vessel, said frame being adapted to be secured in said vessel directly over and sufficiently close to the upper surface of a gel so that electrophoresis buffer from each reservoir can contact an edge of a gel but is substantially blocked from passing underneath the frame or around the frame.

36. An apparatus according to claim 35, wherein said frame has external dimensions substantially similar to the dimensions of the upper surface of the step-up platform.

37. An apparatus according to claim 35, wherein one of said longitudinal members of said frame facing a buffer reservoir is adapted to allow electrophoresis buffer to access the interior of said frame to collect therein.

38. An apparatus according to claim 35, further comprising a gel cover prepared from electrically nonconductive material

39. An apparatus according to claim 38, wherein said cover is sufficient in size to protect a majority of the upper surface of a gel from contact with electrophoresis buffer.

40. An apparatus according to claim 38, wherein said gel cover is a thin sheet made of transparent material.

41. An apparatus according to claim 38, wherein said gel cover is integral to the gel restraining frame.

42. An apparatus according to claim 37, wherein said longitudinal frame member adapted to allow access of electrophoresis buffer has an access whole through the frame member.

43. An apparatus according to claim 37, wherein said longitudinal frame member adapted to allow access of electrophoresis buffer has a height that is shorter than the height of the other frame members, thus allowing buffer to spill over said shorter frame member to collect in the interior of said frame.

44. An apparatus according to claim 35, wherein said frame further comprises buffer separation structure on the side of said longitudinal frame member that faces the interior wall of said vessel.

45. An apparatus according to claim 44, wherein said buffer separation structure is a flexible gasket material.

46. A gel restraining frame for performing discontinuous gel electrophoresis in a vessel having a step-up platform, said restraining frame prepared from electrically nonconductive material and generally rectangular in shape, said frame comprising four longitudinal members surrounding an interior space, wherein two of said longitudinal members are adapted to face toward a buffer reservoir of a vessel and the other two longitudinal members are adapted to face inside walls of such a vessel, said frame being adapted to be secured in such a vessel directly over and sufficiently close to the upper surface of a gel so that electrophoresis buffer from each reservoir can contact an edge of a gel but is substantially blocked from passing underneath the frame or around the frame.

47. A gel restraining frame according to claim 46, wherein one of said longitudinal members of said frame facing a buffer reservoir is adapted to allow electrophoresis buffer to access the interior of said frame to collect therein.

48. A gel restraining frame according to claim 46, wherein said longitudinal frame member adapted to allow access of electrophoresis buffer has an access whole through the frame member.

49. A gel restraining frame according to claim 46, wherein said longitudinal frame member adapted to allow access of electrophoresis buffer has a height that is shorter than the height of the other frame members, thus allowing buffer to spill over said shorter frame member to collect in the interior of said frame.

50. A gel restraining frame according to claim 46, wherein said frame further comprises buffer separation structure on the side of said longitudinal frame member that faces the interior wall of said vessel.

51. A method for separating biological materials in a sample by horizontal gel electrophoresis, said method comprising applying a voltage differential between two electrodes of an electrophoresis apparatus of claim 1, wherein the cassette mounted in the vessel contains a gel cassette with samples in one or more wells of the gel, and wherein said vessel and cassette contain electrophoresis buffer solution, said voltage differential sufficient to cause different biological materials of the sample to migrate into the gel at different rates so that separation of the biological materials takes place.

52. The method according to claim 51, wherein said electrophoresis buffer solution in said first and said second reservoirs is the same.

53. The method according to claim 51, wherein said electrophoresis buffer solution in said first reservoir is different from the running buffer solution in said second reservoir.

54. The method according to claim 51, wherein said gel is a discontinuous gel.

55. A method for separating biological materials in a sample by horizontal gel electrophoresis, said method comprising applying a voltage differential between two electrodes of an electrophoresis apparatus of claim 1, wherein the cassette mounted in the vessel contains a gel cassette with samples in one or more wells of the gel, and wherein said vessel and cassette contain electrophoresis buffer solution, said voltage differential sufficient to cause different biological materials of the sample to migrate into the gel at different rates so that separation of the biological materials takes place.

56. The method according to claim 55, wherein said electrophoresis buffer solution in said first and said second reservoirs is the same.

57. The method according to claim 55, wherein said electrophoresis buffer solution in said first reservoir is different from the running buffer solution in said second reservoir.

58. The method according to claim 55, wherein said gel is a discontinuous gel.
